(19) United States
(12) Patent Application Publication
(10) Pub. No.: US 2014/0172584 A1
(43) Pub. Date: Jun. 19, 2014

(54) OPEN ADVERTISEMENT DISTRIBUTION NETWORK

(71) Applicant: MICROSOFT CORPORATION, Redmond, WA (US)

(72) Inventor: JOSE D. SAURA, KENT, WA (US)

(73) Assignee: MICROSOFT CORPORATION, REDMOND, WA (US)

(21) Appl. No.: 13/718,180

(22) Filed: Dec. 18, 2012

(51) Int. Cl. G06Q 30/02

(52) U.S. Cl. CPC G06Q 30/0277
USPC 705/14.69; 705/14.73

(57) ABSTRACT

Methods, computer systems, and computer-storage media are provided for creating an open advertisement distribution network. A Web server hosting a Web site is accessed. The Web server has an advertisement definition file located at a predefined URL, and the advertisement definition file includes at least one advertisement file. The advertisement file is extracted and communicated to one or more advertisement publishers.

### BACKGROUND

Traditionally, companies or individuals that wish to create an online advertisement contact an advertisement publisher such as, for example, Bing® or Facebook® and use a preconfigured Web form to register an account and to create an advertisement. The advertisement creator follows this process for each advertisement publisher, which can mean countless forms and many hours spent completing the forms. For large companies with large advertising budgets and staff, this process is part of their everyday business. However, for smaller companies or individual advertisers, the task may seem overwhelming and may consume valuable time resources.

Advertisement publishers are typically compensated by the companies or individuals creating the advertisement based on popular metrics such as cost-per-impression (CPI) or cost-per-click (CPC). Although this may bring in substantial revenue for the advertisement publisher, smaller companies and or individuals end up spending a large portion of their advertising dollars on advertisements that may not necessarily lead to a sale.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for, among other things, creating an open advertisement distribution network where a user can place an advertisement file at a predefined location on a Web server, have the advertisement file extracted by a Web crawler, and have the advertisement file communicated to a number of different publishing sites. Moreover, the monetization of such a network can be modeled, in one aspect, on a cost-per-conversion scheme. The open advertisement distribution network can be especially beneficial to smaller companies and/or individuals with limited advertising resources by eliminating the need to fill out multiple, repetitive forms at different publishing sites. Instead, these companies and/or individuals can create a single advertisement file that is distributed to multiple publishers. Moreover, the advertisement creator can set up a centralized account with the network instead of having separate accounts set up with each of the different publishing sites. Using a cost-per-conversion monetization scheme benefits the advertisement creator by making better use of advertising dollars and also benefits the network by increasing the number of participants in the network.

Accordingly, in one embodiment, the present invention is directed to one or more computer-storage media having computer-executable instructions embodied thereon that, when executed by a computing device, cause the computing device to perform a method of creating an open advertisement distribution network. The method comprises accessing at least one Web server having an advertisement definition file located at a predefined uniform resource locator (URL) address associated with the at least one Web server; the advertisement definition file comprising at least a first advertisement file. The at least the first advertisement definition file is extracted from the at least one Web server and is communicated to one or more advertisement publishers.

In another embodiment, the present invention is directed to a computer system for facilitating the communication of advertisement files to a plurality of advertisement publishers. The system comprises a computing device associated with an advertisement distribution service having one or more processors and one or more computer-storage media and a data store coupled with the advertisement distribution service. The advertisement distribution service accesses a plurality of Web servers, where each Web server of the plurality of Web servers has one or more associated advertisement definition files at a predefined uniform resource locator (URL) address associated with the each Web server. The one or more advertisement definition files are extracted from the plurality of Web servers and stored in association with the data store. The advertisement distribution service communicates at least one advertisement file from the one or more advertisement definition files to one or more advertisement publishers.

In yet another embodiment, the present invention is directed to a computerized method carried out by an advertisement distribution service having at least one processor for creating an open advertisement distribution network. The method comprises accessing one of more Web servers having advertisement definition files located at predefined uniform resource locator (URL) addresses associated with the one or more Web servers. At least one advertisement file is extracted from an advertisement definition file associated with at least one Web server of the one or more Web servers. Using the at least one processor, at least one advertisement publisher is determined based on parameters associated with the at least one advertisement file, and the at least one advertisement file is communicated to the at least one publisher.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system for facilitating the communication of advertisement files to one or more advertisement publishers suitable for use in implementing embodiments of the present invention;

FIG. 3 is a process-flow diagram of an exemplary process for facilitating the distribution of advertisement files to advertisement publishers in accordance with an embodiment of the present invention; and

FIGS. 4-5 depict flow diagrams of exemplary methods of creating an open advertisement distribution network in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-storage media for, among other things, creating an open advertisement distribution network where a user can place an advertisement file at a predefined location on a Web server, have the advertisement file extracted by a Web crawler, and have the advertisement file communicated to a number of different publishing sites. Moreover, the monetization of such a network can be modeled, in one aspect, on a cost-per-conversion scheme. The open advertisement distribution network can be especially beneficial to smaller companies and/or individuals with limited advertising resources by eliminating the need to fill out multiple, repetitive forms at different publishing sites. Further, the advertisement creator can set up a centralized account with the network instead of having separate accounts set up with the different publishing sites. Using a cost-per-conversion monetization scheme benefits the advertisement creator by making better use of advertising dollars and also benefits the network by increasing the number of participants in the network.

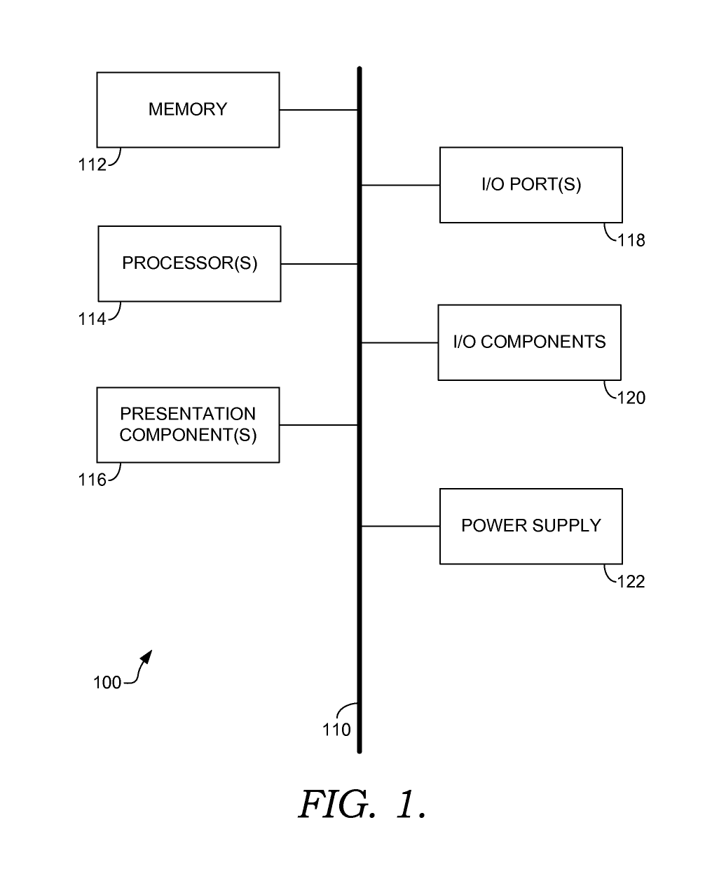

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant, a smart phone, a tablet PC, or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excludes signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

Furthermore, although the term “server” is often used herein, it will be recognized that this term may also encompass a search engine, an advertisement search service, a Web browser, a cloud server, a set of one or more processes distributed on one or more computers, one or more stand-alone storage devices, a set of one or more other computing or storage devices, a combination of one or more of the above, and the like.

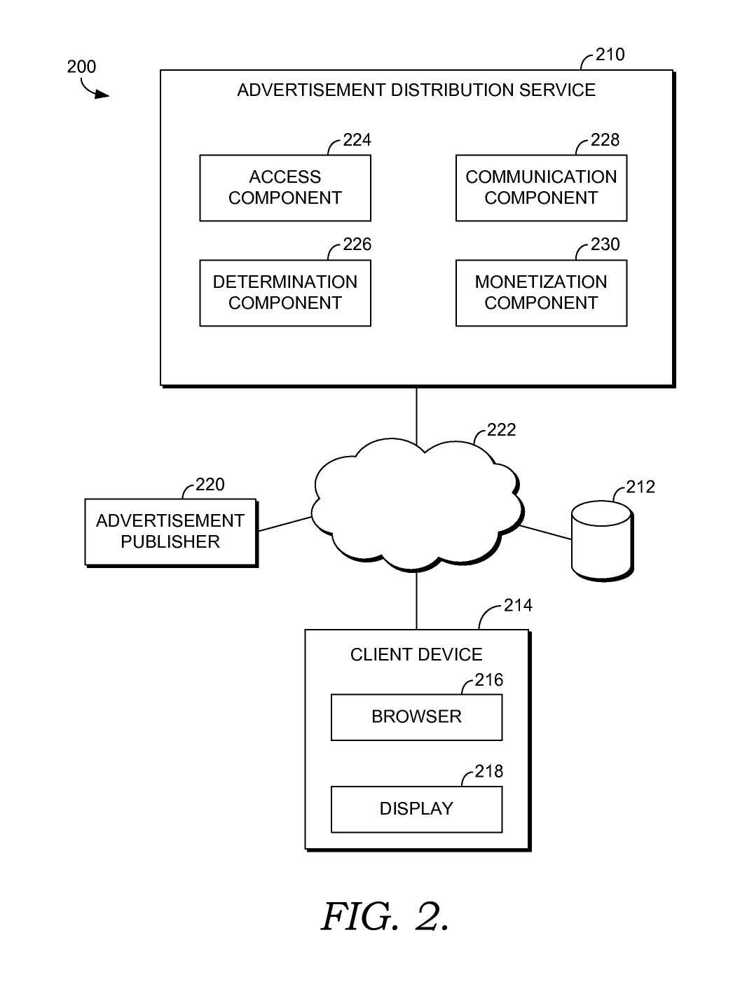

Referring now to FIG. 2, a block diagram is provided illustrating an exemplary computing system 200 in which embodiments of the present invention may be employed. Generally, the computing system 200 illustrates an environment in which users can create advertisement files and place them at predefined uniform resource locator (URL) addresses of Web servers. The advertisement files are extracted from the Web servers and communicated to one or more advertisement publishers. The environment further enables the creation of accounts with each of the users; the accounts may include one or more payments terms based, in one aspect, on a cost-per-conversion model. User compliance with payment terms may affect the frequency with which the user's associated advertisement file is communicated to advertisement publishers.

Among other components not shown, the computing system 200 generally includes an advertisement distribution service 210, a data store 212, a client device 214, and an advertisement publisher 220 all in communication with one another via a network 222. The network 222 may include, without limitation, one or more local area networks (LANs) and/or wide area networks (WANs). Such networking environments are commonplace in offices, enterprise-wide computer networks, intranets and the Internet. Accordingly, the network 222 is not further described herein.

It should be understood that any number of client computing devices and advertisement distribution services may be employed in the computing system 200 within the scope of embodiments of the present invention. Each may comprise a single device/interface or multiple devices/interfaces cooperating in a distributed environment. For instance, the advertisement distribution service 210 may comprise multiple devices and/or modules arranged in a distributed environment that collectively provide the functionality of the advertisement distribution service 210 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the client device 214, as an Internet-based service, as a third-party application service, or as a module inside the advertisement distribution service 210. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search services, third-party applications, or client computing devices. By way of example only, the advertisement distribution service 210 might be provided as a single server (as shown), a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The client computing device 214 may include any type of computing device, such as the computing device 100 described with reference to FIG. 1, for example. Generally, the client computing device 214 may include a browser 216 and a display 218. The browser 216, among other things, is configured to render search home pages, advertisement publishing pages, search results pages (SRPs), and the like in association with the display 218 of the client computing device 214. The browser 216 is further configured to receive user input of requests for various Web pages (including search home pages, advertisement publisher pages, and/or results pages), receive user-inputted search queries (generally inputted via a user interface presented on the display 218 and permitting alpha-numeric and/or textual input, voice input, and/or gesture input into a designated search box), and to receive content for presentation on the display 218, for instance, from the advertisement distribution service 210. The browser 216 may be any suitable type of Web browser such as Internet Explorer®, Firefox®, Chrome®, Safari®, or other type of software configured to enable submission of search queries as disclosed herein. It should be noted that the functionality described herein as being performed by the browser 216 may be performed by any other application capable of rendering Web content. Any and all such variations, and any combination thereof, are contemplated to be within the scope of embodiments of the present invention.

The display 218 is configured to present various content including, without limitation, browser home pages, search engine home pages, advertisement publishing pages, advertisements, and results pages, as described herein. As used throughout this application, the term “results page” is meant to encompass Web pages such as search engine results pages, and/or result pages associated with search-type applications, either standalone or embedded in other applications (e.g., Xbox®, Microsoft® Office, and the like). In embodiments, the display 218 is further configured to enable touch inputs, auditory inputs, and/or gesture inputs from a user.

The advertisement publisher 220 may comprise any service and/or company that publishes or delivers advertisements either via the Web or in print. Such companies are numerous but representative examples may include public search engines such as, for example, Bing®, paid search services, social network sites such as Facebook® or Twitter®, social news sites such as Reddit®, social photo and video sharing sites such as YouTube®, social bookmarking sites such as Pinterest® and other third-party application sites, blogs, email marketing companies, and the like. Although only one advertisement publisher is illustrated in FIG. 2, it is contemplated that the computer system 200 may encompass any number of advertisement publishers.

The advertisement distribution service 210 is configured to receive and respond to requests and/or communications that it receives from components associated with client computing devices. Such requests may comprise requests from the browser 216 as well as communications received, via, for example, from an electronic mail messaging service associated with the client computing device 214. The advertisement distribution service 210 is further configured to receive and respond to requests received directly from advertisement publishers such as the advertisement publisher 220.

As illustrated, the advertisement distribution service 210 includes an access component 224, a determination component 226, a communication component 228, and a monetization component 230. In some embodiments, one or more of the components 224, 226, 228, and 230 may be implemented as stand-alone applications. In other embodiments, one or more of the components 224, 226, 228, and 230 may be integrated directly into the operating system of a computing device such as the computing device 100 of FIG. 1 or the client device 214. It will be understood that the components 224, 226, 228, and 230 illustrated in FIG. 2 are exemplary in nature and in number and should not be construed as limiting. Any number of components may be employed to achieve the desired functionality within the scope of embodiments hereof.

The illustrated advertisement distribution service 210 also has access to the data store 212. The data store 212 is configured to store information for use by, for example, the advertisement distribution service 210. The information stored in association with the data store 212 is configured to be searchable for one or more items of information stored in association therewith. The information stored in association with the data store 212 may comprise general information used by the advertisement distribution service 210. For example, the data store 212 may store information concerning accounts established with users who are utilizing the advertisement distribution service 210. Account information may comprise user-identifying information, user contact information, registered payment instruments, payment terms, a log of payments received from the user, and the like.

The data store 212 may also store information concerning advertisement files that have been extracted from Web servers. Information may include the identity of a user who created the advertisement file, publishers to whom the advertisement file was communicated, how often the advertisement file has been communicated, and an engagement history with the advertisement including selections utilizing mouse clicks or gestures, and, if known, conversions associated with the advertisement file. The data store may also store cached advertisement files.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the advertisement distribution service 210, the client device 214, and/or any combination thereof.

The access component 224 of the advertisement distribution service 210 is configured to access Web servers and to extract advertisement definition files located at predefined URL addresses associated with the Web server. As used throughout this application, the term “Web server” is meant to encompass a server that hosts a Web site; the server delivers Web pages to browsers as well as other data files to Web-based applications. In one aspect, the access component 224 acts as a Web crawler and initiates communication with the Web server by making a request for advertisement definition files located at a predefined URL address. The advertisement definition files, in turn, may have been placed on the Web server by the creator of the advertisement definition file.

In general, the advertisement files associated with a Web server correspond in some way to the content associated with the server's respective Web site. For example, a Web site having content related to holiday gifts may have associated advertisement files on the server directed to the holiday gifts. In one aspect, the advertisement files associated with a Web site are created by the company or individual sponsoring the site. In another aspect, the Web site may be hosted by a third-party and have advertisement files contributed by different users of the site. For instance, in this situation, a single advertisement definition file may contain a first advertisement file created by a first user and a second advertisement file created by a second user. An example of this may by a classified advertisement Web site such as, for example, Craigslist®, where users can list items for sale. If the item seller wished to advertise beyond Craigslist®, the user could create an advertisement file and place it at a predefined URL on the Craigslist® server. The advertisement file could subsequently be disseminated to other advertisement publishing pages, which increases the likelihood of a sale. Other Craigslist® users could create and upload their own advertisement files.

The advertisement definition file associated with a Web server may include one or more advertisement files structured using a standard schema such as, for example, Java Script Object Notation (JSON) or Extensible Markup Language (XML). Each advertisement file may include a number of user-defined parameters. An exemplary schema is provided below to illustrate the type of parameters that may be associated with an advertisement file. The schema provided below is for illustrative purposes only and is not meant to limit the scope of the invention. More or less parameters may be included in an advertisement file without departing from the spirit and scope of the invention described herein.

```
<ad>
    <id>uniqueid</id>
    <sinlgleLineText> </sinlgleLineText>
    <doubleLineText><line1></line1<line2><line2> <doubleLineText>
    <longTitle></longTitle>
    <description format=”text”></description>
    <description format=”html”></description>
    <!--collection of images-->
    <images>
    <Image aspectRatioX=”x” aspectRatioY′=”x”> url </image>
    </images>
    <startDateTime></endDateTime>
    <endDateTime></endDateTime>
    <discount type=”amount\percent></discount>
    <itemValue units=””></itemValue>
    <disclosure></disclosure>
    <restrictions></restrictions>
    <transactionUrl></transactionUrl>
    <inventoryUrl>
    <!-endpoint that can return current ad status and inventory ad
    runtime -->
    <inventoryUrl>
    <trackingUrl>
    <!-endpoint that can receive ad usage statitsics from the
    publisher at runtime-->
    <itrackingUrl>
    <itemsOffered>,/itemsOffered>
    <itemsAvailable>,/itemsAvailable>
    <itemsRedeemed>,/itemsRedeemed>
    <status>enable\disabled</status>
    <javascript type=”web”><javascript>
    <javascript type=”mobile”><javascript>
    <dateCreated/>
    <dateUpdated/>
    <target>
    <!-- target parameters control when, where and to whom the ad
    should ideally be shown: geo, demographics,  temporal,
    networks-->
    <target>
    <merchant ID>
    <email address/>
    <phone/>
    <name/>
    </merchant>
    <categories>
    <-- must conform to standard -->
    </categories>
    <publishers>
    <publisher name=””>
    <!-custom hints or data for a specifc publisher -->
    </publisher>
    </publishers>
    </ad>
    <ad link=“url”/>
    </ads>
```

As can be seen from the schema provided above, some of the parameters are directed to advertisement content and type of advertisement. Advertisement types may include contextual advertisements, banner advertisements, rich media advertisements, interstitial advertisements, pop-up advertisements, incentive advertisements, and the like. Advertisement parameters may also indicate preferred method of display (e.g., mobile phone display, tablet display, hard print, etc.).

Some of the advertisement parameters may be used to set up an advertisement account with the advertisement creator. Parameters useful for this may include a merchant ID, an email address of the user who created the file, a name, a contact phone number and/or address, and the like. Additionally, some of the advertisement parameters may be used to determine advertisement publishers suited to present the advertisement. Parameters useful for determining an advertisement publisher may include an advertisement category, target audience parameters, preferred publisher parameters, and the like.

Besides including one or more advertisement files, the advertisement definition file may further include URLs linking to other sites on the Web server where additional advertisement files may be located. This is especially useful when multiple advertisement files are uploaded to the advertisement definition file.

As mentioned, the advertisement definition file is located at a predefined URL address on the Web server. The address is the same for all Web servers. Placing advertisement files at predefined locations on Web servers enables the access component 224 to make calls to the same location across a broad range of Web sites, which, in turn, reduces processing times. By way of illustrative purposes only, one predefined location may comprise “ad.atom.” After extracting the advertisement files associated with the advertisement definition file, the access component 224 is configured to process the files and store the files in association with a data store such as the data store 212. Processing may comprise discarding advertisements that are structured improperly or lack information regarding the advertisement creator such as contact information.

The determination component 226 of the advertisement distribution service 210 is configured to determine advertisement publishers that, in one aspect, meet at least a portion of the parameters specified in the advertisement file. Parameters used to determine advertisement publishers may comprise an advertisement category, target parameters specifying, for example, a target demographic segment, a target geographic segment, and time restrictions for when the advertisement should be presented, specified publisher preferences, type of advertisement (e.g., banner, pop-up, rich media, etc.), and the like.

The communication component 228 is configured to communicate the advertisement file to those advertisement publishers determined to meet the parameters specified in the advertisement file such as, for example, the advertisement publisher 220. A single advertisement file may be communicated to more than one advertisement publisher. The communication component 228 is further configured to receive communications from the advertisement publisher regarding, for example, user engagement with the advertisement as shown by, for example, hovers, clicks, selections, gestures, and the like. Alternatively, or in addition to the above, the communication component 228 is also configured to present the advertisement file on a Web page associated with the advertisement distribution service 210. Users can access the Web page by opening a browser of an application and searching for advertisements related to a particular subject.

The monetization component 230 is configured to, among other things, generate an account with the creator of the advertisement file. As shown above, the advertisement file schema includes contact information for the advertisement creator such as an email address, a physical address, and/or a telephone number. Once an advertisement file is extracted from a Web server, the monetization component 230 is configured to send a confirmation message, such as an email, to the advertisement creator. Upon receiving a response from the advertisement creator, thus verifying that the contact information is valid, the monetization component 230 creates a user account and communicates the account information to the advertisement creator. It is not necessary for the advertisement creator to register a payment instrument at the time the advertisement file is placed on the Web server for an account to be created.

The account may specify initial payment terms based on, for example, how frequently the advertisement file is anticipated to be distributed to advertisement publishers, payment terms associated with advertisements similar to the particular advertisement file, expected user engagement with the advertisement, and the like. In one aspect, the payment terms may be communicated to the advertisement creator after a trial run period is concluded. During the trial run period, the advertisement may be distributed to advertisement publishers a specified number of times without cost to the advertisement creator. End-user response during this trial run period gives an indication to the advertisement creator of how successful the advertisement is before deciding to invest further money in the advertisement campaign.

The monetization component 230 is configured to monitor user compliance with the payment terms and to adjust the distribution of the advertisement accordingly. For instance, full compliance with payment terms may guarantee that the advertisement will be distributed at a predefined frequency. Partial compliance with payment terms may reduce the frequency with which the advertisement is distributed, and failure to comply with payment terms may cause the communication component 228 to cease communicating the advertisement to the advertisement publisher.

The monetization component 230 is also configured to receive end-user engagement information from advertisement publishers or to monitor end-user engagement information when the advertisement is presented on a Web page associated with the advertisement distribution service 210. User-engagement information may include hovers, selections, clicks, and/or gestures related to the advertisement. Such information may be used by the monetization component 230 to adjust payment terms. For instance, if there is strong user engagement with the advertisement, payment terms may be increased. Conversely, if there is little user engagement with the advertisement, payment terms may be decreased. The monetization component 230 is further configured to communicate to the advertisement creator user engagement information so that the advertisement creator can monitor the efficacy of the advertisement. User engagement information may be communicated to the advertisement creator via, for example, email or by providing a Web portal through which the advertisement creator can access the information.

In one aspect, the monetization component 230 is configured to calculate payment terms based on a cost-per-conversion model. A conversion may be defined as a user engagement with the advertisement that leads to, for example, a sale or a lead for the advertisement creator. In one aspect, the advertisement creator may report conversion information to the monetization component 230 where it may be used to adjust payment terms. The advertisement creator may report conversion information via, for example, email or by using the Web portal as described above.

Conversion information may also be monitored by, for example, using a merchant ID specified in the advertisement file schema to track actual sales generated by the advertisement. By including the merchant ID in the advertisement file schema, the monetization component 230 can contact an intermediate payment processing or auditing service that can mediate and track payments made to the merchant in order to ensure that the monetization component 230 can account for all transactions. The merchant agrees to notify the intermediate service whenever at transaction takes place. The monetization component 230 is either notified by the intermediate service when a transaction takes place, or the monetization component 230 can contact the intermediate service directly to download a batch of transactions. The monetization component 230 is further configured to reimburse advertisement publishers based on payments received from the advertisement creator.

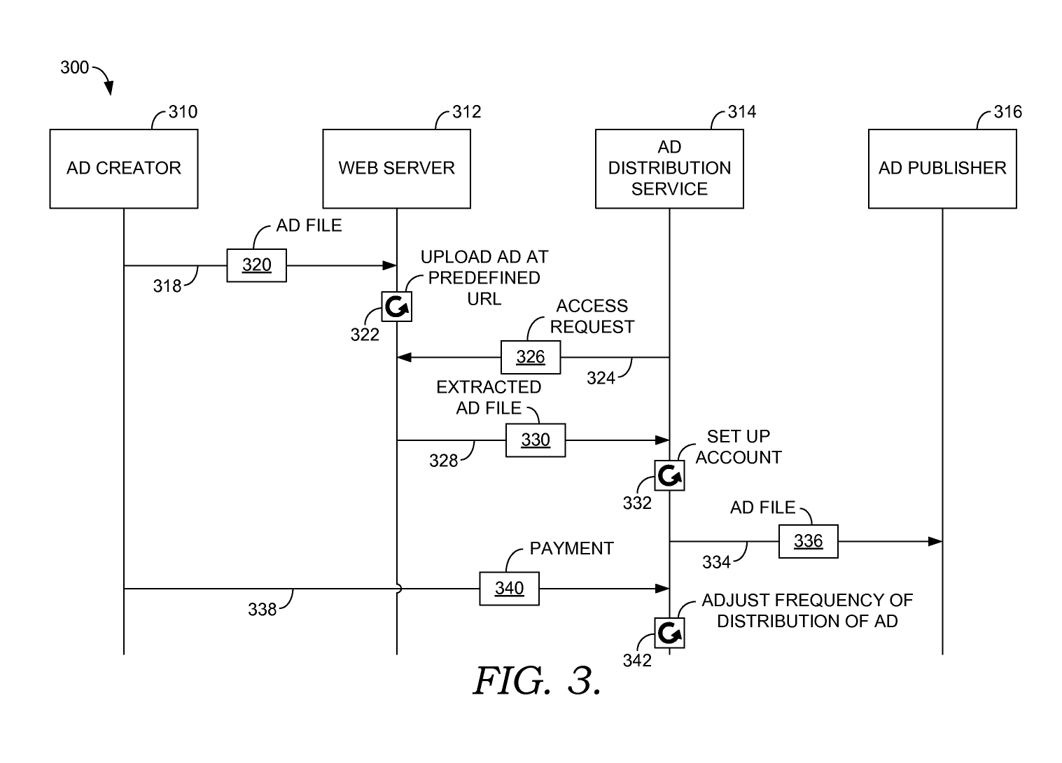

Turning now to FIG. 3, a process-flow diagram, referenced generally by the numeral 300, is depicted illustrating a method of facilitating the distribution of advertisement files placed at predefined locations on Web servers to advertisement publishers. FIG. 3 includes an advertisement creator 310, a Web service 312 associated with a Web site, an advertisement distribution service 314, and an advertisement publisher 316.

The advertisement creator 310 may comprise an individual, a merchant, a group, a company, and the like. The Web service 312 may host a Web site sponsored by the advertisement creator 310, or the Web site may be hosted by a third-party unrelated to the advertisement creator 310. The advertisement distribution service 314 may correspond to the advertisement distribution service 210 of FIG. 2, and the advertisement publisher 316 may correspond to the advertisement publisher 220 of FIG. 2. Although only one advertisement publisher is shown, it is contemplated that there may be numerous advertisement publishers.

At a step 318, the advertisement creator 310 communicates an advertisement definition file 320 to the Web service 312. The advertisement definition file 320 may comprise one or more advertisement files structured using a standard schema such as XML or JSON. Each advertisement file may include numerous parameters specifying, among other things, advertisement content, contact information, target audience parameters, advertisement category, preferred publisher data, URLs, merchant ID, and the like. The advertisement definition file 320 may also include one or more URLs specifying additional locations on the Web server having advertisement files.

At a step 322, the Web service 312 uploads the advertisement definition file 320 at a predefined URL address that is the same across all the Web servers utilizing the advertisement distribution service 314. At a step 324, the advertisement distribution service 314 sends an access request 326 to the Web service 312, and, at a step 328, the advertisement distribution service 314 extracts the advertisement definition file which is now labeled as advertisement definition file 330. Although not shown, the advertisement distribution service 314 may process the advertisement definition file by extracting at least one advertisement file associated with the advertisement definition file, parsing the information in the advertisement file, storing the advertisement file in association with a data store such as the data store 212 of FIG. 2, and communicating a confirmation message to the advertisement creator 310. In one aspect, parsing may include discarding advertisement files that are improperly structured or do not contain contact information.

Using some of the information parsed from the advertisement file, such as merchant ID, contact information, type of advertisement, start and stop dates for the presentation of the advertisement, publisher preferences, and the like, the advertisement distribution service 314 sets up a user account with one or more payment terms at a step 332. The payment terms are flexible and may be adjusted based on, for example, end-user engagement with the advertisement. Engagement may be measured by hovering over or selecting the advertisement, or generating a sale from the advertisement. In one aspect, the payment terms may become effective after a trial period of advertisement distribution expires. By way of example, the advertisement distribution service 314 may distribute the advertisement file a predefined number of times to a predefined number of publishers before the payment terms become effective.

At a step 334, an advertisement file 336 extracted from the advertisement definition file 330 is communicated by the advertisement distribution service 314 to the advertisement publisher 316 where it is subsequently published. The advertisement distribution service 314 may also publish the advertisement 336 to its own Web page where it can be accessed by end users. At a step 338, a payment 340 is received by the advertisement distribution service 314 from the advertisement creator 310. Depending upon whether the payment 340 meets payment terms in the account, at a step 342 the advertisement distribution service adjusts the frequency of distribution of the advertisement 336. For example, if the advertisement creator 310 pays the required amount, the frequency of distribution is maintained. However, if the advertisement creator 310 pays less than the amount required by the payment terms, the frequency of distribution is adjusted downward. If no payment is received from the advertisement creator 310, the advertisement distribution service 314 may cease to display the advertisement file 336 or to communicate the advertisement file 336 to the advertisement publisher 316.

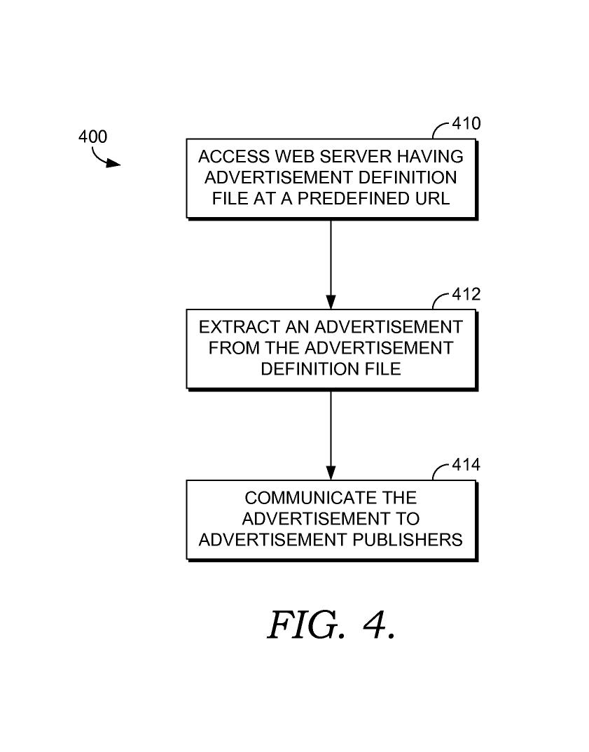

Turning to FIG. 4, a flow diagram is depicted of an exemplary method 400 of creating an open advertisement distribution network. At a step 410, a Web server is accessed by an access component such as the access component 224 of FIG. 2. The Web server has an advertisement definition file located at a predefined URL address, and the advertisement definition file includes at least one advertisement file. Additionally, the advertisement definition file may include one or more URLs linking to other advertisement files located on the Web server. At a step 412, the advertisement file is extracted by the access component.

The advertisement file may be structured according to a standardized schema such as XML or JSON and may include parameters specifying advertisement content information, identifying information for the advertisement creator, target audience parameters, publisher preferences, advertisement categories, and the like. In one aspect, the parameters, such as advertisement category, target audience parameters, publisher preferences, and/or advertisement type are used to determine advertisement publishers having characteristics that match at least some of the parameters. For instance, parameters specifying that the advertisement falls within a “sports” category may be communicated to advertisement publishers who have sports enthusiasts as an audience. Parameters such as merchant ID, user-identifying information, contact information, type of advertisement, start and stop times to run the advertisement, preferred advertisement publisher, and the like may also be used to create a user account with one or more payment terms based on the parameters. The advertisement definition file and its associated advertisement files may be stored in a data store such as the data store 212 of FIG. 2.

At a step 414, the advertisement file is communicated by a communication component such as the communication component 228 of FIG. 2 to one or more advertisement publishers who subsequently publish the advertisement. Alternatively, or in addition to the above, the advertisement file may be presented on a Web page sponsored by the advertisement distribution network. The advertisement publishers may provide feedback to the advertisement distribution service regarding user engagement with the advertisement, which, in turn, may be used to adjust the payment terms associated with the advertisement. As well, the advertisement creator may also provide feedback regarding conversions associated with the displayed advertisement via email or uploading information via a Web portal. The feedback may be used to adjust account payment terms either upward or downward. In another aspect, conversion information associated with the advertisement may be obtained through an intermediate independent payment processing or auditing service as explained above. Any and all such aspects, and any combination thereof, are contemplated as being within the scope of the invention.

The method 400 may further comprise extracting a second advertisement file located at one of the reference URL addresses specified in the advertisement definition file and communicating the second advertisement file to one or more of the advertisement publishers based on parameters in the second advertisement file. The second advertisement file may be created by the same creator as the initial advertisement file, or the second advertisement file may be created by a different creator than the initial advertisement file.

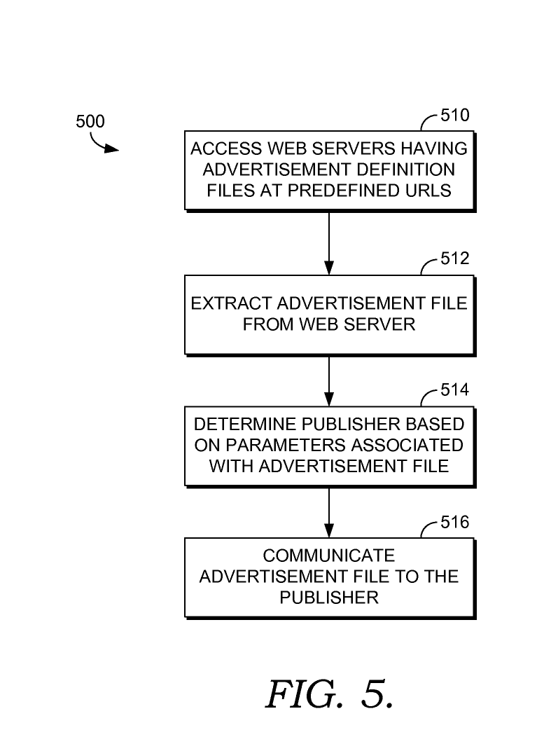

FIG. 5 depicts another flow diagram of an exemplary method 500 of creating an open advertisement distribution network. At a step 510, a Web server having an advertisement definition file located at a predefined URL is accessed, and, at a step 512, an advertisement file is extracted from the advertisement definition file. As described above, the advertisement file may include parameters specifying, for example, a category associated with the advertisement file, preferred advertisement publishers, and parameters specifying a target audience based on demographic features, geographical features, time period during which the advertisement is displayed, and the like. At a step 514, at least one advertisement publisher is determined based on at least a portion of the parameters associated with the advertisement file. The determination may be made by a determination component such as the determination component 226 of FIG. 2. At a step 516, the advertisement file is communicated to the determined advertisement publisher where it may be subsequently published. Publishing the advertisement may comprise publishing the advertisement on a Web page, in an electronic mail message, or publishing the advertisement on a hard copy which is later distributed through conventional channels such as direct mail.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-storage media having computer-executable instructions embodied thereon that, when executed by a computing device, cause the computing device to perform a method of creating an open advertisement distribution network, the method comprising:
accessing at least one Web server having an advertisement definition file located at a predefined uniform resource locator (URL) address associated with the at least one Web server, the advertisement definition file comprising at least a first advertisement file;
extracting from the at least one Web server the at least the first advertisement file; and
communicating the at least the first advertisement to one or more advertisement publishers.

2. The media of claim 1, wherein the at least the first advertisement file is structured using at least one of Java Script Object Notation (JSON) or Extensible Markup Language (XML).

3. The media of claim 1, wherein the advertisement definition file further comprises a reference to at least a second advertisement file located at a second URL address associated with the at least one Web server.

4. The media of claim 3, further comprising:
extracting the at least the second advertisement file located at the second URL address associated with the at least one Web server; and
communicating the at least the second advertisement to one or more advertisement publishers.

5. The media of claim 4, wherein a creator of the at least the first advertisement file is the same as a creator of the at least the second advertisement file.

6. The media of claim 4, wherein a creator of the at least the first advertisement file is different from a creator of the at least the second advertisement file.

7. The media of claim 1, further comprising storing the at least the first advertisement file in association with a data store.

8. The media of claim 1, wherein the at least the first advertisement file includes user contact information for a user associated with the at least one advertisement definition file.

9. The media of claim 8, further comprising utilizing the user contact information to establish an advertising account with the user, the advertising account specifying one or more payment terms.

10. The media of claim 9, wherein the communication of the at least the first advertisement to the one or more publishers is dependent upon satisfaction by the user of the one or more payment terms.

11. A system for facilitating the communication of advertisement files to a plurality of advertisement publishers, the system comprising:
a computing device associated with an advertisement distribution service having one or more processors and one or more computer-storage media; and
a data store coupled with the advertisement distribution service,
wherein the advertisement distribution service:
accesses a plurality of Web servers, each Web server of the plurality of Web servers having one or more associated advertisement definition files at a predefined uniform resource locator (URL) address associated with the each Web server;
extracts the one or more advertisement definition files from the plurality of Web servers;
stores the one or more advertisement definition files in association with the data store; and
communicates at least one advertisement file from the one or more advertisement definition files to one or more advertisement publishers.

12. The system of claim 11, wherein the predefined URL address associated with the each Web server is the same across the plurality of Web servers.

13. The system of claim 11, wherein the at least one advertisement file comprises a plurality of parameters, and wherein at least a portion of the plurality of parameters comprises target parameters.

14. The system of claim 13, wherein the target parameters are utilized to determine in part the one or more advertisement publishers to whom the at least one advertisement file is communicated.

15. The system of claim 14, wherein the target parameters comprise one or more of an advertisement category, a target demographic segment, a target geographic segment, and time for display restrictions.

16. A computerized method carried out by an advertisement distribution service having at least one processor for creating an open advertisement distribution network, the method comprising:
accessing one of more Web servers having advertisement definition files located at predefined uniform resource locator (URL) addresses associated with the one or more Web servers;
extracting at least one advertisement file from an advertisement definition file associated with at least one Web server of the one or more Web servers;
determining, using the at least one processor, at least one advertisement publisher based on parameters associated with the at least one advertisement file; and
communicating the at least one advertisement file to the at least one advertisement publisher.

17. The method of claim 16, wherein the parameters associated with the at least one advertisement file comprise in part contact information for a user who created the at least one advertisement file.

18. The method claim 17, further comprising subsequent to communicating the at least one advertisement file to the at least one advertisement publisher, communicating a confirmation message to the user who created the at least one advertisement file using the contact information.

19. The method of claim 17, further comprising communicating one or more payment terms to the user using the contact information.

20. The method of claim 19, wherein the one or more payment terms are dependent upon conversions associated with the at least one advertisement file.
